(19) United States
(12) Patent Application Publication
(10) Pub. No.: US 2017/0200982 A1
(43) Pub. Date: Jul. 13, 2017

(54) RECHARGEABLE BATTERY CONTAINING ZINC IONS

(71) Applicant: TTSB S.R.L., Cascina (IT)

(72) Inventor: Pasquale TORRE, Livorno (IT)

(21) Appl. No.: 15/319,614

(22) PCT Filed: Jun. 15, 2015
(86) PCT No.: PCT/IB2015/054504

§ 371 Date: Dec. 16, 2016

(30) Foreign Application Priority Data
Jun. 16, 2014 (IT) LI2014A000005

(51) Int. Cl. H01M 10/36; H01M 4/62; H01M 4/58; H01M 4/38; H01M 4/36; H01M 4/50

(52) U.S. Cl. CPC H01M 10/36; H01M 4/366; H01M 4/50; H01M 4/58; H01M 4/38; H01M 4/625; H01M 4/623; H01M 2300/0002

(57) ABSTRACT

The present invention relates to a electrochemically active mixture, working within a rechargeable battery. This mixture consists of manganese oxide and potassium hexacyanoferrate as active phase, an electronically conductive material and a polymeric binder. The mixture above described is used as a component of the positive electrode in rechargeable batteries, where the negative electrode consists of zinc, tin or manganese metal. Thanks to its peculiar characteristics the battery obtained is able to reproduce more than 10,000 cycles with a loss of storage capacity of not greater than 10% and an open circuit voltage greater than 1.5 V.

### FIELD OF THE INVENTION

The current invention relates to the field of rechargeable batteries as power supply of electrical devices.

### STATE OF THE ART

The demand of energy storage devices has greatly increased during the last decade, to be used in a large number of appliances, such as electronic devices, electric vehicles and renewable energy storage (eg. wind or solar energy).

Unlike a primary battery, a rechargeable battery (or secondary) can perform several cycles of charge and discharge, resulting much more economical and durable. Due to the growing demand for secondary batteries for energy storage, it is increasingly necessary and urgent the development of a new rechargeable battery, able to overcome the most currently used, ie the lithium-ion battery, in performances and environmental compatibility.

Rechargeable batteries that currently on the market have many formulations.

These systems are designed to have a relatively high working voltage, typically comprised between 3.3 and 4.2 V; therefore non-aqueous electrolytes, which are stable at voltages higher than 4 V, are required. However, this implies several drawbacks: firstly, the conductivity of these organic electrolytes (which are, first of all, toxic and hazardous for the environment) is much lower than that of aqueous electrolytes. Therefore the batteries with non-aqueous electrolyte must have very thin and porous electrodes, together with a much more complicated design, with high surface area current collectors; all these aspects causes high design costs. In the second place, it is necessary to maintain a moisture free environment during assembly of the batteries, increasing the complexity and the cost of management and manufacturing.

A class of batteries that is arising a considerable interest is that of batteries based on zinc ions, as zinc is easily available in nature, and therefore not expensive. However, the characteristic problem of the batteries containing zinc ions is the limited number of charge and discharge cycles (due to the formation of dendritic structures), and therefore the typical lifetime of such devices.

Numerous attempts have been made to increase both the number of cycles and the working voltage. For example in the patent CN102299389 the active material adopted for the cathode is manganese dioxide, while the anode is zinc; the electrolyte consists of an aqueous solution containing zinc ions and various surfactants which should improve the battery performance, increasing capacity and durability.

However after 100 charge-discharge cycles, the capacity goes from an initial value of 210 mAh/g to 70 mAh/g, without of surfactant, and to 130 mAh/g in presence of sodium dodecyl benzene sulfonate as anionic surfactant.

A similar behaviour is that described in patent CN102013526: it consists of a zinc-ion battery that uses manganese dioxide doped with Nickel (Ni0.2 MnO₂ 0.8) in the cathode, a zinc plate of 0.1 mm thick as anode, and a solution 1 mol/L of ZnSO₄. This battery has a capacity of 170 mAh/g. The capacity after just 10 cycles decreases to 150 mAh/g.

Particular interesting is the solution described in the patent CN102903917. It describes a rechargeable zinc-ion battery containing aqueous electrolyte, consisting of copper (nickel) ferricyanide as cathodic active material, zinc as anodic active material and an aqueous solution of soluble zinc salts as electrolyte. According to the invention, the zinc ions can be inserted in the lattices of the cathodic electrode of copper (nickel) ferricyanide or removed by the same. Simultaneously the anodic material is subjected to oxidation or reduction; the battery has a capacity of 150 mAh/g (the weight is calculated according to the active material on the cathodic electrode) and efficiency of 78%, with charge voltage comprised between 2.1 and 2.2 V and discharge voltage of 0.75 V. However these potentials are insufficient to power directly the most common electronic devices currently on the market.

The invention set up by the Applicant is focused on a rechargeable energy storage system that uses an aqueous electrolyte-based zinc sulfate. Thanks to the result developed by the Applicant it had been possible to make a device able to operate for at least 5000 cycles, with a capacity loss of less than 10%, compared to the initial one.

### SUMMARY OF THE INVENTION

Surprisingly, the Applicant has developed a new energy storage device, based on metallic zinc, and zinc ions in the anodic material, and manganese dioxide decorated with copper hexacyanoferrate in the cathode.

The main advantages of the present invention, in addition to high specific capacity, long life-time and the ability to run numerous cycles of charge and discharge, consists in the use of not-expensive, non-polluting and widely available materials, such as zinc, copper hexacyanoferrate and zinc sulfate.

### DETAILED DESCRIPTION OF THE INVENTION

The present invention is focused in providing a rechargeable energy storage system that uses an aqueous electrolyte, specifically a basic aqueous solution of zinc sulfate.

The working method of the device consists of an oxidation process (transfer of electrons) from the zinc anodic material with simultaneous insertion of zinc ions in the cathode material, made by manganese dioxide decorated with copper hexacyanoferrate, alternated to a reduction process (acquisition of electrons) of anode electrode, simultaneously with the expulsion of the zinc ions from the cathodic electrode. The rechargeable battery characteristic is obtained thanks to charge/discharge processes associated with the reversible transfer of the Zn cations between the cathodic electrode and the anodic electrode, using an electrolyte solution containing Zn cations that acts primarily as ionic conductor between the two mentioned electrodes. During the initial stage of charge and during the following steps of charging, zinc cations are removed from the cathodic active material; on the opposite, when the system is discharged, the Zn cations intersect in the active cathodic material.

The electrochemical energy storage device here described includes an anode consisting of zinc, a cathode consisting of manganese dioxide powder decorated with copper hexacyanoferrate, a separator and an electrolyte consisting of an aqueous solution of zinc sulfate 0.5M-3M or an aqueous solution of zinc sulfate 0.5M-3M and sodium sulfate 0.5M-1 M.

The active material of the negative electrode can be made by pure metallic zinc (powder or pellets) or in combination with metals or conductive materials of carbonaceous type (for example but not limited to, graphite, Ketjen Black, Carbon Black, Vulcan). In this second instance, the weight amount of pure zinc can be comprised between 0.75 and 1.

The active material of the positive electrode is made by MnO₂ powder and KxCu[Fe(CN)₆], 1<x<1.7, an electron conductor carbonaceous material and a bonding agent. The electronic conductor above mentioned can be coal, Vulcan, Ketjen Black, Acetylene Black. The binder can be polytetrafluoroethylene (PTFE) or polyvinilydienfluoride (PVDF). In the mixture MnO₂/KxCu[Fe(CN)₆], 1<x<1.7, the amount of manganese oxide can be comprised between 70 and 90 wt %, considering the total weight of the active material.

In the mixture which constitutes the raw material of the positive electrode, the amount by weight of electronic conductor material may be between comprised 15 and 25 wt %, while the amount of binder may be between 5 and 15 wt %, where the 100% is the sum of all the species contained in the positive electrode (active materials, conductive support and binder).

The device is able to perform between 5000 and 10000 of charge/discharge cycles, with capacity loss less than 10%, compared to the initial one. It shows a specific capacity equal to or greater than 200 mAh per gram of active cathodic material and a specific energy equal to or greater than 300 Wh per kg of active cathodic material, when the charge and discharge cycles are obtained working between 1.9 V and 0, 9 V, in an electrolytic solution as described above.

The present invention can be better understood in the light of the following examples of embodiment.

### EXPERIMENTAL PART

### Example 1

### Preparation of Cathodic Catalyst 14-50, Based on Manganese Dioxide Decorated with Copper Hexacyanoferrate KxCu [Fe(CN)₆]

To a solution containing 100 g of sulfuric acid in 400 mL of deionised water are added 90 g of potassium permanganate; the mixture is heated under continue stirring at a temperature of 80° C. for 10 h, till the formation of a very fine powder of black colour. After filtration and repeated washing with deionised water, the solid is dried at a temperature of 80° C. in a drying oven, for the preparation of the manganese dioxide powder.

10 g of manganese dioxide obtained by the above described synthesis are dispersed in 1 L of deionised water; an amount equal to 0.2 mol of copper sulfate (II) or copper nitrate (II) is added to this dispersion and it is solubilised under continuous stirring. Subsequently, after the addition of 0.1 mol of potassium hexacyanoferrate K₄[Fe(CN)₆], the reaction of decoration of the manganese dioxide with copper hexacyanoferrate is promoted maintaining the temperature at 70° C. for one hour under agitation.

The suspension red brick-coloured so obtained is mixed with an amount of Vulcan XC72 equal to 15 g, and the dispersion is promote with ultrasonic vibration and stirring for one hour. After the addition of 10 grams of polytetrafluoroethylene (dispersion in water 60 wt %), it can be noted a gradual thickening of the mixture which is completed after 30 minutes of stirring. The solid, filtered and washed repeatedly with deionised water, is used for the preparation of the cathodic electrode.

### Example 2

### Preparation of Cathodic Catalyst 25-40, Based on Manganese Dioxide Decorated with Copper Hexacyanoferrate KxCu [Fe(CN)₆]

To a solution containing 100 g of sulfuric acid in 400 mL of deionised water are added 90 g of potassium permanganate; the mixture is heated under continue stirring at a temperature of 80° C. for 10 h, till the formation of a very fine powder of black colour. After filtration and repeated washing with deionised water, the solid is dried at a temperature of 80° C. in a drying oven, for the preparation of the manganese dioxide powder.

18 g of manganese dioxide obtained by the above described synthesis are dispersed in 1 L of deionised water; an amount equal to 0.16 mol of copper sulfate (II) or copper nitrate (II) is added to this dispersion and it is solubilised under continuous stirring. Subsequently, after the addition of 0.08 mol of potassium hexacyanoferrate K₄[Fe(CN)₆], the reaction of decoration of the manganese dioxide with copper hexacyanoferrate is promoted maintaining the temperature at 70° C. for one hour under agitation.

The suspension red brick-coloured so obtained is mixed with an amount of Vulcan XC72 equal to 15 g, and the dispersion is promote with ultrasonic vibration and stirring for one hour. After the addition of 10 grams of polytetrafluoroethylene (dispersion in water 60 wt %), it can be noted a gradual thickening of the mixture which is completed after 30 minutes of stirring. The solid, filtered and washed repeatedly with deionised water, is used for the preparation of the cathodic electrode.

### Example 3

### Preparation of the Cathodic Electrode

1.4 g of the catalytic paste, obtained according to the procedure 1 and 2 of the cathode catalyst synthesis above described, is spread on 5 cm² of a porous substrate of nickel foam (density 340 g/m² and thickness 1.6 mm); subsequently the electrode is dried for 30 minutes in a drying oven at a temperature of 150° C. and rolled to a final thickness of 0.4 mm.

The example was repeated by coating the paste catalyst, as described above, on a graphite substrate or on a stainless steel plate SS316, pre-drilled, obtaining similar results.

### Example 4

### Working Test with Zinc Sulphate Solution

In order to test the behaviour of batteries, a prototype was assembled consisting of a positive electrode, made according to the examples 1 and 3, and a sheet of zinc metal as negative electrode. The two plates are both placed in contact with a non-woven fabric soaked in a zinc sulfate solution 2M. The battery thus obtained is loaded for 1 hour at 200 mA until the voltage of 2V.

At the end of this step, after a further stop of 1 h, the recorded OCV is 1.86 V.

The discharge cycle is obtained applying an electrical load at constant current of 200 mA. The registered capacity is 196 mA/h per gram of active phase.

The discharge voltage drops from 1.86 V up to 0.8 V.

### Example 5

### Working Test with Zinc Sulphate Solution and Sodium Sulfate

A prototype was assembled consisting of a positive electrode, made according to the examples 1 and 3, and a sheet of zinc metal as negative electrode. The two electrodes are both placed in contact with a non-woven fabric soaked in a zinc sulfate solution 2M and sodium sulphate 1 M. The battery thus obtained is loaded for 1 hour at 200 mA until the voltage of 2.1V.

At the end of this step, after a further stop of 1 h, the recorded OCV is 2.03 V.

The discharge cycle is obtained applying an electrical load at constant current of 200 mA. The registered capacity is 196 mA/h per gram of active phase.

The discharge voltage drops from 2.03 V up to 0.8 V.

### Example 6

### Lifetime Test

According to the procedure reported in example 4, the recorded values of voltage and capacity are:

1° cycle OCV=1.86 V capacity=196 mAh
10° cycle OCV=1.86 V capacity=196 mAh
100° cycle OCV=1.86 V capacity=196 mAh
1000° cycle OCV=1.88 V capacity=194 mAh
5000° cycle OCV=1.90 V capacity=190 mAh
15000° cycle OCV=1.96 V capacity=184 mAh

The electric capacity is relative to 1 g of active metal phase in the positive electrode.

1. An electrically active mixture containing:
manganese(IV) dioxide in an amount comprised between 50 and 70 wt %, considering the total weight;
potassium hexacyanoferrate in an amount comprised between 5 and 30 wt %, considering the total weight;
an electrically active material in an amount comprised between 10 and 40 wt %, considering the total weight;
a polymeric binder in an amount comprised between 5 and 20 wt %, considering the total weight;

2. The rechargeable battery in which the positive electrode is made by the mixture of claim 1 and the negative electrode consists of zinc, tin or metallic manganese.

3. The rechargeable battery according to claim 2, wherein the electrolyte consists of an aqueous solution of zinc sulfate of a concentration of comprised between 0.5 M and 3 M or of an aqueous solution of zinc sulfate 0.5M-3M and sodium sulfate 0.5M-1M.

4. The rechargeable battery according to claims 2, in which the open circuit voltage (OCV), is greater than 1.5 V.

5. The rechargeable battery according to claim 3, in which the open circuit voltage (OCV), is greater than 1.5V.
